(19) United States
(12) Patent Application Publication
(10) Pub. No.: US 2025/0251091 A1
(43) Pub. Date: Aug. 7, 2025

(54) COOLING SYSTEM USING ELLIPTICAL SPIRAL COOLING TUBES AND FERRO MAGNETIC FLUID UNDER MAGNETIC FIELD FOR HYDROGEN STORAGE IN METAL HYDRIDES

(71) Applicant: KING FAISAL UNIVERSITY, AL-AHSA (SA)

(72) Inventors: FATIH SELIMEFENDIGIL, AL-AHSA (SA); GUREL SENOL, AL-AHSA (SA)

(21) Appl. No.: 18/433,735

(22) Filed: Feb. 6, 2024

(51) Int. Cl. F17C 11/00; F28F 13/12

(52) U.S. Cl. CPC F17C 11/005; F28F 13/125; F17C 2227/0341; F17C 2227/039

(57) ABSTRACT

Hydrogen is cooled during storage in the form of a metal hydride. A storage tank or container with a metal hydride precursor is provided with at least one spiral cooling tube, configured with an elliptical cross-section. A coolant fluid is caused to flow within the spiral cooling tube. Hydrogen is combined with the hydride precursor to provide a metal hydride bed within the storage tank or container, and, while combining the hydrogen with the metal, heat is extracted through the spiral cooling tube. A swirling flow within the spiral cooling tube is used to improve the heat transfer in the system and enhance the hydrogen absorption process. Ferromagnetic nanoparticles in the coolant fluid are used within the spiral cooling tube. and electromagnets to establish a magnetic field interacting with ferromagnetic nanoparticles in the coolant fluid to establish flow and improve heat transfer.

### BACKGROUND

### Technical Field

The present disclosure relates to gas cooling, and more particularly to cooling of hydrogen gas converted to metal hydrides in a container. Specifically the disclosure relates to the use of elliptical spiral cooling tubes and ferromagnetic fluid for hydrogen storage in metal hydrides.

### Background Art

Hydrogen storage is used to provide an alternative means of energy storage due to its mobility, economical benefits and environmentally friendly behavior. Many methods have been performed in order to keep thermal management in its best way while storing hydrogen. Hydrogen absorption is an exothermic reaction, so it is important to prevent the system from absorbing heat which would result in high temperature values, because the need to extract more heat from the system result in more time being necessary for the absorption process. Some of the methods to improve the cooling process of the system include using water jackets, phase change materials, and keeping the system's heat transfer surface area as large as possible by using fins, etc.

### SUMMARY

Hydrogen is cooled during storage in the form of a metal hydride. A storage tank or container with a metal hydride precursor is provided with at least one spiral cooling tube therein, and a coolant fluid is caused to flow within the spiral cooling tube. Hydrogen is combined with the hydride precursor to provide a metal hydride bed within the storage tank or container, and, while combining the hydrogen with the metal, heat is extracted through the spiral cooling tube. A swirling flow within the spiral cooling tube is used to improve the heat transfer in the system and enhance the hydrogen absorption process.

In one particular configuration, the spiral cooling tube is configured with an elliptical cross-section. In a further configuration, ferromagnetic nanoparticles in the coolant fluid are used within the spiral cooling tube. and electromagnets to establish a magnetic field interacting with ferromagnetic nanoparticles in the coolant fluid to establish flow and improve the heat transfer in the system and enhance the hydrogen absorption process. The magnetic field interacts with the ferromagnetic nanoparticles and the elliptical cross-section to create swirling flow within the cooling tube and thereby improve the heat transfer in the system and enhance the hydrogen absorption process.

### BRIEF DESCRIPTION OF THE DRAWINGS

FIG. 1 is a schematic diagram showing a hydrogen storage tank for storing hydrogen as a metal hydride, in which internal helical heat exchange tubes are used to cool the hydrogen and hydride.

FIG. 2 is a schematic diagram showing details of heat exchange tubes used in the configuration of FIG. 1.

FIG. 3 is a detailed view of one of the heat exchange tubes of FIG. 2.

FIG. 4 is a cross-section of the tank of FIGS. 1 and 2, showing heat exchange tubes and the flow direction of the ferro fluid.

### DETAILED DESCRIPTION

The present disclosure describes heat transfer used to effect hydrogen storage, and in particular, hydrogen storage using metal hydride hydrogen storage tanks or containers. Cooling techniques in hydrogen storage is important since storage process time depends on the heat extracted from the storage tank or container. The storage tank or container is fitted with internal helical heat exchange tubes which are used to provide cooling of the storage tank or container. In one aspect, the present disclosure is implemented by hydrogen storage using metal hydride hydrogen storage tanks or containers, in which the tank or container has a plurality of internal helical heat exchange tubes which transfer heat to coolant fluid within the heat exchange tubes. In a particular configuration, the helical heat exchange tubes have elliptical cross-sections.

In order to provide a good thermal management during the absorption process, the cooling process must occur as quickly as possible. The quicker the cooling process is, the less time is spent for the absorption of the desired mass of hydrogen in the tank or container.

In one aspect, the present disclosure is implemented by hydrogen storage using metal hydride hydrogen storage tanks or containers containing a metal hydride precursor, in which the tank or container has a plurality of internal helical heat exchange tubes which have elliptical cross-sections and carry a magnetic coolant fluid. Magnets are positioned external to the tank or container, although it is noted that the description of the magnetic fluid and the magnets provided to us in the invention disclosure makes their function unclear. Magnets are used to drive the magnetic fluid rather than conventional pumps.

For heat transfer enhancement, active and passive heat transfer methods have been performed and one of these passive heat transfer enhancement methods uses specific design configurations which differ according to the specific system. Accordingly, the present examples are presented to show the operational aspects of the claimed technology. Hydrogen is stored in a metal hydride bed by combining the hydrogen with a metal hydride precursor, and is cooled in the metal hydride bed. According to one technique, the cooling tubes are spiral and they have elliptical cross-sections. The provision of spiral tubes being is intended to provide improved heat transfer between the metal hydride bed and the heat transfer fluid. Heat transfer is further enhanced by an elliptical profile of the cooling tubes. Creating a swirling flow using magnetic field is implemented to improve the heat transfer in the system and thus enhance the hydrogen absorption process.

In order to create a swirling flow, a magnetic nanofluid, also known as ferro fluid, is used in the cooling tubes. A non-limiting example of a magnetic nanofluid (or ferro fluid) is Fe₃O₄. A magnetic field is established perpendicular to the magnetic nanofluid, due to its position, and is applied to a heat transfer fluid in the system. In the disclosed cooling system, better thermal management and effective storage of hydrogen in metal hydrides is provided.

### EXAMPLES

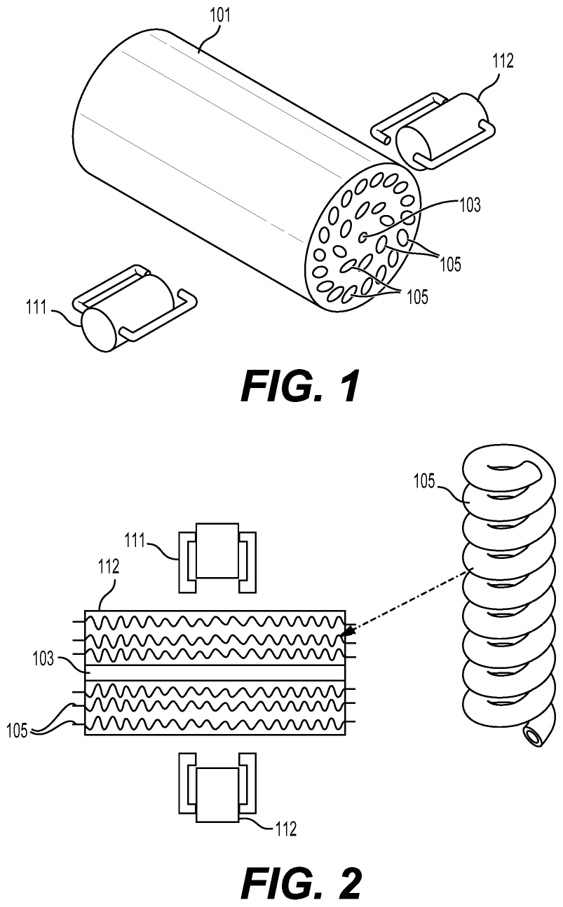

FIG. 1 is a schematic diagram showing a hydrogen storage tank for storing hydrogen as a metal hydride, in which internal helical heat exchange tubes are used to cool the hydrogen and hydride. Depicted are tank 101, with hydrogen supply tube 103 and heat exchange tubes 105. Also depicted are electromagnets 111, 112 positioned to interact with fluid within heat exchange tubes 105.

FIG. 2 is a schematic diagram showing details of heat exchange tubes 105 used in the configuration of FIG. 1. The major fill of tank 101 is metal hydride, with heat exchange tubes 105 embedded in the metal hydride or its precursor. Hydrogen supply tube 103 passes through the center of tank 101.

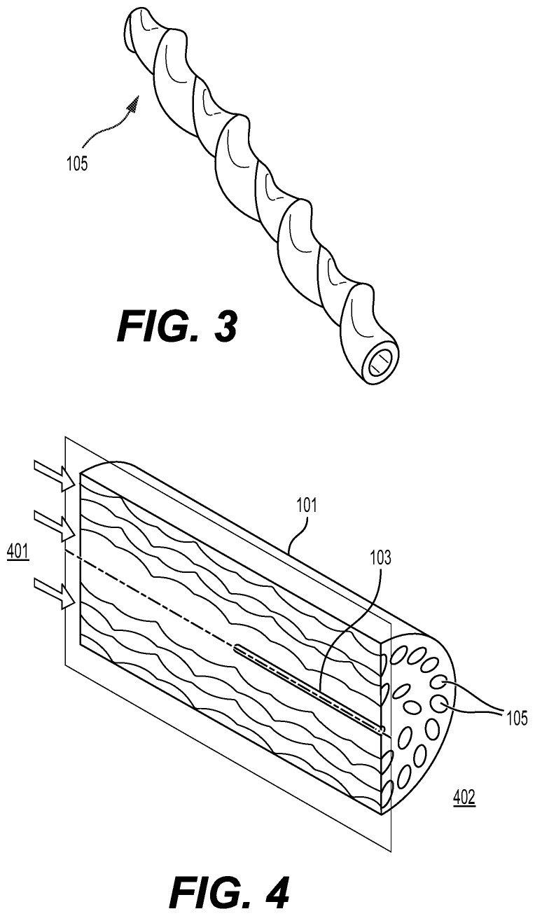

FIG. 3 is a detailed view of one of the heat exchange tubes 105. Each heat exchange tube is constructed as a spiral tube having an elliptical profile or cross-section. A nanofluid having ferromagnetic properties, described as a ferro fluid, flows through heat exchange tube 105, and is driven by electromagnets 112, 113 (FIGS. 1 and 2).

FIG. 4 is a cross-section of the tank of FIGS. 1 and 2, showing heat exchange tubes 105 and the flow direction of the ferro fluid.

### CLOSING STATEMENT

It will be understood that many additional changes in the details, materials, steps and arrangement of parts, which have been herein described and illustrated to explain the nature of the subject matter, may be made by those skilled in the art within the principle and scope of the invention as expressed in the appended claims.

1. A method for cooling hydrogen stored in the form of a metal hydride, using metal hydride hydrogen storage tanks or containers, the method comprising:
providing a storage tank or container with a metal hydride precursor and at least one spiral cooling tube extending axially into the storage tank or container;
providing said at least one spiral cooling tube with an elliptical cross-section, said spiral cooling tube fitted within the storage tank or container so as to maintain a separation of fluid within the spiral cooling tube from the metal hydride precursor, while providing a heat exchange relationship between fluid within the spiral cooling tube and the metal hydride precursor within the storage tank or container;
providing a coolant fluid for flow within said at least one spiral cooling tube;
combining hydrogen with a metal in the metal hydride precursor to provide a metal hydride bed within the storage tank or container, and, while combining the hydrogen with the metal, extracting heat through said at least one spiral cooling tube while maintaining the separation of cooling fluid within the spiral cooling tube from the metal hydride precursor;
providing, ferromagnetic nanoparticles, comprising Fe₃O₄, in the coolant fluid for flow within said at least one spiral cooling tube; and
using electromagnets to establish a magnetic field interacting with ferromagnetic nanoparticles in the coolant fluid, said using electromagnets interacting with ferromagnetic nanoparticles in the cooling fluid creating a swirling flow within said at least one spiral cooling tube to augment the heat transfer in the system and provide an enhanced hydrogen absorption process while maintaining the separation of cooling fluid within the spiral cooling tube,
wherein the magnetic field interacting with the ferromagnetic nanoparticles and the elliptical cross-section creates swirling flow to augment the heat transfer in the system and enhance the hydrogen absorption process.

2. (canceled)

3. (canceled)

4. (canceled)

5. The method of claim 1, further comprising:
providing an inlet tube extending into the storage tank or container and using the inlet tube to supply hydrogen into the storage tank or container, for storage as the metal hydride.

6. The method of claim 1, further comprising:
providing an inlet tube extending into the storage tank or container and using the inlet tube to supply and discharge hydrogen into the storage tank or container, for storage as the metal hydride and discharge from the metal hydride.

7. A hydrogen storage system having a cooling function for cooling hydrogen stored in the form of a metal hydride, using metal hydride hydrogen storage tanks or containers, the hydrogen storage system comprising:
a storage tank or container with a metal hydride precursor and at least one spiral cooling tube extending axially into the storage tank or container and having an elliptical cross-section, said at least one spiral cooling tube providing a flow path for coolant fluid, said spiral cooling tube fitted within the storage tank or container so as to maintain a separation of fluid within the spiral cooling tube from the metal hydride precursor, while providing a heat exchange relationship between fluid within the spiral cooling tube and the metal hydride precursor within the storage tank or container;
a metal hydride bed, wherein a precursor for metal hydride combines hydrogen with a metal in the metal hydride precursor to provide the metal hydride bed within the storage tank or container, and while combining the hydrogen with the metal in the metal hydride precursor, said at least one spiral cooling tubes extract heat through said at least one spiral cooling tube while maintaining the separation of cooling fluid within the spiral cooling tube from the metal hydride precursor; and
a flow generator creating a swirling flow within said at least one spiral cooling tube to augment the heat transfer in the system and provide an enhanced hydrogen absorption process,
wherein the flow generator comprises an electromagnet driving ferromagnetic nanoparticles, comprising Fe₃O₄, in the coolant fluid to cause flow within said at least one spiral cooling tube, and wherein the electromagnet establishes a magnetic field interacting with the ferromagnetic nanoparticles in the coolant fluid to augment the heat transfer in the system and enhance the hydrogen absorption process while maintaining the separation of cooling fluid within the spiral cooling tube,
and wherein the magnetic field interacting with the ferromagnetic nanoparticles and the elliptical cross-section creates swirling flow to augment the heat transfer in the system and enhance the hydrogen absorption process.

8. (canceled)

9. (canceled)

10. (canceled)

11. The hydrogen storage system of claim 7, further comprising:
an inlet tube extending into the storage tank or container and using the inlet tube to supply hydrogen into the storage tank or container, for storage as the metal hydride.

12. The hydrogen storage system of claim 7, further comprising:
an inlet tube extending into the storage tank or container and using the inlet tube to supply and discharge hydrogen into the storage tank or container, for storage as the metal hydride and discharge from the metal hydride.

13. A hydrogen storage system having a cooling function for cooling hydrogen stored in the form of a metal hydride, using metal hydride hydrogen storage tanks or containers, the hydrogen storage system comprising:
a storage tank or container with a metal hydride precursor and at least one spiral cooling tube extending axially into the storage tank or container and having an elliptical cross-section, said at least one spiral cooling tube providing a flow path for coolant fluid, said spiral cooling tube fitted within the storage tank or container so as to maintain a separation of fluid within the spiral cooling tube from the metal hydride precursor, while providing a heat exchange relationship between fluid within the spiral cooling tube and the metal hydride precursor within the storage tank or container;
a metal hydride bed, wherein a precursor for metal hydride combines hydrogen with a metal in the metal hydride precursor to provide the metal hydride bed within the storage tank or container, and while combining the hydrogen with the metal in the metal hydride precursor, said at least one spiral cooling tubes extract heat through said at least one spiral cooling tube while maintaining the separation of cooling fluid within the spiral cooling tube from the metal hydride precursor; and
flow generation means for creating a swirling flow within said at least one spiral cooling tube to augment the heat transfer in the system and provide an enhanced hydrogen absorption process, said flow generation means comprising electromagnets to establish a magnetic field interacting with ferromagnetic nanoparticles, comprising Fe₃O₄, in the coolant fluid to augment the heat transfer in the system and enhance the hydrogen absorption process, said using electromagnets interacting with ferromagnetic nanoparticles in the cooling fluid creating a swirling flow within said at least one spiral cooling tube while maintaining the separation of cooling fluid within the spiral cooling tube,
wherein the magnetic field interacting with the ferromagnetic nanoparticles and the elliptical cross-section creates swirling flow to augment the heat transfer in the system and enhance the hydrogen absorption process.

14. (canceled)
